(19) United States
(12) Patent Application Publication
(10) Pub. No.: US 2016/0293146 A1
(43) Pub. Date: Oct. 6, 2016

(54) Tamber Stick

(71) Applicant: John Z. Finelli III, El Cajon, CA (US)

(72) Inventor: John Z. Finelli III, El Cajon, CA (US)

(21) Appl. No.: 14/676,675

(22) Filed: Apr. 1, 2015

(51) Int. Cl. G10D 13/02

(52) U.S. Cl. CPC G10D 13/02

(57) ABSTRACT

The invention relates to a tambourine which includes jingle members mounted on a plastic frame, a hand gripping end, and a slapstick on one end. The disclosed tambourine is straight in shape which provides additional strength to the jingles and prevents its breaking. In another embodiment a tambourine having a plurality of jingles member mounted on the frame wherein said frame is like a tunning fork, gripping end and a slapstick further comprising of a set of batteries in the handle, one or more LED lights on both sides of said fork, and a button mounted in between the said slapstick and said fork.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention relates to an improved construction for tambourines, and particularly relates to a tambourine having a plastic frame and an improved mounting arrangement for the jingles.

(2) Background of the Invention

Tambourines, is musical instruments capable of producing a variety of sounds. In their simplest form, these instruments include a frame or shell with a series of windows formed therein, and paired sets of jingles that are supported for movement within the window. A percussive sound is produced by hitting, shaking, or otherwise vibrating the frame so as to move the jingles within the window. In some embodiments, the instrument may further include a stretched membrane disposed over an end of the shell. This membrane can be used as a means for vibrating the jingles or alternately producing tones by means of beating or otherwise vibrating the stretched membrane.

Conventional tambourines are fabricated with a circular frame of wood or similar material to which jingles are mounted, usually by the use of steel pins which extend through transverse bores in the frame, or nails, or driven screws through the frame, which intersect jingle slots in the frame. Vigorous play can cause the jingle pins, nails or screws to loosen and fall out.

Also in case of conventional tambourine, the entertainer or musician grasps one side of the frame and shakes or vibrates the entire tambourine so that the jingles are caused to engage each other and cause the typical tambourine sound to be produced. Conventionally, tambourines have a mainframe or a body which is a hoop-shaped or tubular member usually of wood. In windows formed in the frame are mounted jingles made of sheet metal and arranged in pairs and loosely retained on shafts or pins carried by the frame. This frame or hoop, when held in the hand of and shaken by the entertainer for a period of time, often causes a holding strain or even blisters on the hand of the performer. To prevent this strain and discomfort the frame of the tambourine of this invention is provided with a handgrip formed or attached to the inside of one portion of said frame.

It is an object of the present invention to provide a new and improved tambourine having a durable frame and an improved jingle arrangement in straight stick to withstand vigorous playing.

In addition present invention resolves the problem of drumstick which is combined with other instruments. A skilled drummer can produce complex, rapid rhythms from the array of drums and snares in his kit. To perform well, a drumstick must be lightweight, balanced in its weight distribution, and durable. In addition, it must have a combination of hardness and elastic modulus that contribute to producing the precise sound quality a drummer seeks. This has been typically achieved by selecting the type of wood from which the drumstick is made. Without proper balance and weight, fluid bounce and consistent impact of the drum are lost. The design of the striking tip is also important for proper bounce-back and to avoid damage to drum heads and cymbals. Each of these qualities may be compromised when it is attempted to incorporate a second instrument into a drumstick.

Various attempts have been made to form a tambourine like instrument such as those found in U.S. Pat. Application Nos. 20130239777 to Patrick Timothy Sullivan, James Edward Brisco, Thomas Patrick Davis; 20100058919 to Rice James A and many more. Those prior art depicts a straight stick by attaching jingles to the exterior of the stick, either as a single cymbal pair or as an array of cymbals. These devices suffer from the drawback that the mass of the jingle apparatus displaces the center of gravity of the instrument so that it no longer lies in the axis of the drumstick, and so the instrument is unbalanced. The effect is lessened in an instrument comprising only one pair of jingles, but the volume of sound that can be produced is significantly reduced. Such designs have not achieved significant marketplace acceptance.

It is also known to mount jingles within a sturdy wooden stick to produce a jingle stick. However, each of these designs suffers from the drawback that the weight and bulkiness of the construction required to achieve durability renders them unsuitable for use as drumsticks.

The ability of a drummer to produce a tambourine-like sound in precise synchronization with his drumming is a valuable and one-handed operation frees the other hand for other tasks. However, to gain acceptance, such a design must be lightweight, balanced, durable, and have a combination of hardness and elastic modulus that provides the sound quality a drummer seeks.

For the foregoing reasons, there is a need for a tambourine or a combination of tambourine with a drum stick that combines the low weight, durability, elastic modulus, and hardness of a quality drumstick with the ability to produce a tambourine-like sound. That the present inventions satisfy these needs and more will become apparent to one of ordinary skill upon reading the disclosure, figures appended hereto.

### SUMMARY OF THE INVENTION

In the view of the foregoing disadvantages inherent in the known types of Tambourine now present in the prior art, the present invention provides an improved Tambourine. As such, the general purpose of the present invention, which will be described subsequently in greater detail, is to provide a new and improved Tambourine, which has all the advantages of the prior art and none of the disadvantages.

In accordance with the invention, there is provided a tambourine having jingle members mounted on a plastic frame. The frame is formed as straight stick having 5 sets of giggles and slapstick on one end.

It is an object of this invention to provide, and it does so provide, a tambourine having a frame with a hand grip portion.

It is a further object of this invention to provide, and it does provide, a tambourine preferably having a molded frame of plastic enabling a positive and inexpensive assembly procedure to be established for the manufacture of said tambourine.

A further object of the invention is to provide a musical toy which is easily stored in a pocket and adapted for children.

It is an object of this invention to provide a tambourine with the LED lights that light up when a player hits on the stick.

Other objects of this invention are the provision of a toy instrument which may be inexpensive to manufacture, easy to operate and safe to use.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 represents a plan view showing the preferred arrangement of the tambourine of this invention with a contoured handgrip as provided on the frame.

### DETAILED DESCRIPTION OF THE INVENTION

In the following detailed description, reference is made to the accompanying FIGURE which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical changes may be made without departing from the spirit and scope of the present invention. The following detailed description is, therefore, not to be taken in a limiting sense, and the scope of the present invention is defined by the appended description and their equivalents.

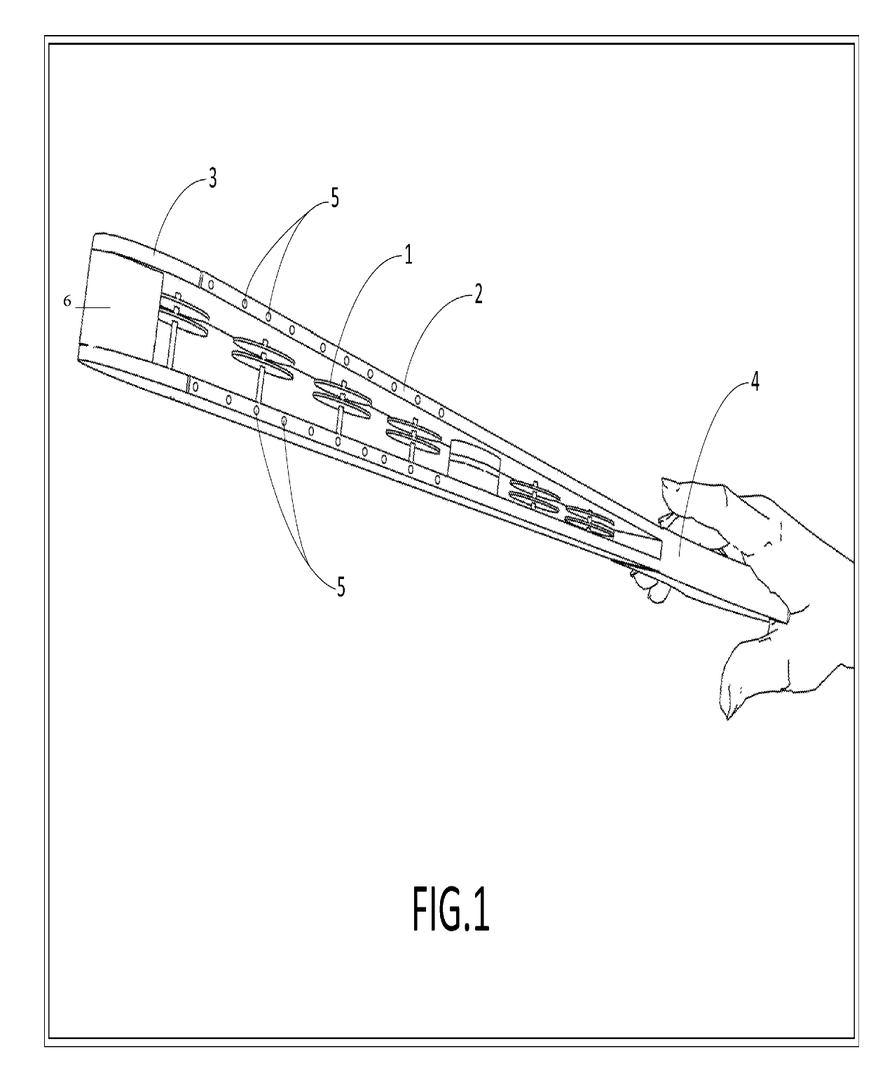

Referring now to FIG. 1, a tambourine comprises plurality of jingle member 1 mounted on a plastic frame 2, a hand gripping 3 ends and slapstick 4 on one end. In tambourine all jingles are mounted in a straight line on between two to six pairs with an extra slip stick.

In preferred embodiment tambourine in mass made up of plastic while its little part is made up of wood or some other kind of metal. Preferably present musical instrument is 1 and a half inches wide and 19 inches long, shaped like a tuning fork. Between the forks, to you have six sets of jingles.

In another embodiment arrangement of gong within the body of the instrument is effectively protected against breakage or displacement, and by connecting the same directly to one of the heads the vibrations thereof are effectively increased and prolonged and the gong itself adds to the volume of sound.

In another embodiment the tamber stick having a set of batteries in the handle with a set of LED lights 5 on both sides of the fork part of the Tamberstick that light up when a player hits the stick. The button is mounted between the slapstick and the fork part so when it slaps on hand or leg the light comes on. Also on the handle is a Mic pick up with a plug which is plug into an amplifier for more sound or improved sound. You can make it as long or short as desired with more or less jingles.

On the use of present musical instrument one can hold it in the hand (left or right) with the help of handling and slap it on the leg or in the palm of other hand which produces a musical sound. In addition, it is easily stored in a pocket and adapted for children.

Advantageously, the present tambourine is straight in shape which makes it different from other existing round shape tambourine. Also this stick structure provides additional strength to the jingles and prevents its breaking. Sometimes this modification may also use in drumstick.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the is scope of the invention is not limited to these embodiments. Many variations, modifications, additions and improvements to the embodiments described above are possible. It is contemplated that these variations, modifications, additions and improvements fall within the scope of the invention.

1. A tambourine comprises:
a plurality of metal jingle member;
a frame;
a hand gripping end;
a top middle member;
a slapstick;
a rechargeable and replaceable battery; and
a plurality of LED lights.

2. The tambourine as specified in claim 1, wherein a majority of said frame in mass made up of lightweight plastic while a remaining portion is made up of wood or metal.

3. (canceled)

4. The tambourine as specified in claim 1, wherein said frame, said hand gipping end and said slapstick form a body of said tambourine.

5. A tambourine as specified in claim 1, wherein said frame having a long tunning fork shape attached to said hand gripping end at the low portion and to said top middle member at upper portion.

6. (canceled)

7. A tambourine as specified in claim 1, wherein said tambourine further comprises at least two sets of jingles and said slapstick on one end.

8. (canceled)

9. The tambourine as specified in claim 1, wherein said battery is placed in said hand gripping forming a cylindrical space to hold said batteries.

10. The tambourine as specified in claim 1, wherein said LED lights are equally distributed on both sides of said frame.

11. A tambourine as specified in claim 1, further comprising a Mic pick up with a plug which is plug into an amplifier for more sound or improved sound.
